(19) United States
(12) Patent Application Publication
(10) Pub. No.: US 2026/0210297 A1
(43) Pub. Date: Jul. 23, 2026

(54) MORE COMPACT AIRCRAFT PROPULSION SYSTEM

(71) Applicant: SAFRAN AIRCRAFT ENGINES, PARIS (FR)

(72) Inventor: Didier René André ESCURE, MOISSY-CRAMAYEL (FR)

(73) Assignee: SAFRAN AIRCRAFT ENGINES, Paris (FR)

(21) Appl. No.: 19/140,136

(22) PCT Filed: Dec. 22, 2023
(86) PCT No.: PCT/FR2023/052100

§ 371 Date: Sep. 3, 2025

(30) Foreign Application Priority Data
Dec. 22, 2022 (FR) FR2214352

(51) Int. Cl. F02C 7/36; F02K 3/02; F04D 19/00; F04D 29/32

(52) U.S. Cl. CPC F02C 7/36; F02K 3/02; F04D 29/321; F05D 2200/12; F05D 2200/13; F05D 2200/14; F05D 2200/211; F05D 2200/221; F05D 2220/3218; F05D 2220/323

(57) ABSTRACT

A propulsion system includes a fan rotor connected to a fan shaft, a first spool including a first turbine that drives the fan rotor via a first shaft, and a second spool including a second turbine and a second axial compressor. The second turbine is two-stage and drives the second compressor via a second shaft. The second shaft rotates at a higher speed than a rotation speed of the first shaft, and a hub-to-tip ratio at an inlet of the second compressor is between 0.41 and 0.60. A reduction structure couples the first shaft and the fan shaft to drive the fan shaft at a rotation speed lower than the rotation speed of the first shaft. The second spool has a relationship among an average outer radius of the second compressor, an average outer radius of the second turbine, a number of stages in the second compressor, a several constants.

### TECHNICAL FIELD

The present application generally relates to the field of propulsion systems, and more particularly to aeronautical propulsion systems comprising a ducted on undetected fan having a high or even very high bypass ratio.

### BACKGROUND

A propulsion system generally includes, from upstream to downstream in the direction of gas flow, a fan section, a compressor section that may comprise a low-pressure compressor and a high-pressure compressor, a combustion chamber and a turbine section that may comprise in particular a high-pressure turbine and a low-pressure turbine. The high-pressure compressor is driven in rotation by the high-pressure turbine via a high-pressure shaft. The fan and, where applicable, the low-pressure compressor are driven in rotation by the low-pressure turbine via a low-pressure shaft.

Technological research efforts have already led to very significant improvements in the environmental performance of airplanes. The Applicant takes into account the factors that have an impact on all design and development phases to obtain less energy-intensive, more environmentally friendly aeronautical components and products, the integration and use of which in civil aviation have moderate environmental consequences, with the aim of improving the energy efficiency of airplanes.

Thus, in order to improve the propulsive efficiency of the propulsion system and reduce its specific consumption as well as the noise emitted by the fan section, propulsion systems with a high bypass ratio BPR (corresponding to the ratio between the flow rate of the secondary air stream and the flow rate of the primary air stream) have been proposed. To achieve such bypass ratios, the fan section can be decoupled from the low-pressure turbine, thus making it possible to independently optimize their respective rotation speed. Generally, the decoupling is achieved using a reduction mechanism placed between the upstream end of the low-pressure shaft and a rotor of the fan section.

The rotor of the fan section is then driven by the low-pressure shaft via the reduction mechanism at a rotation speed lower than that of the low-pressure shaft.

### SUMMARY

One aim of the present application is to optimize the performances of the propulsion system, particularly its footprint and its overall dynamics, without penalizing the efficiency or the mechanical strength of the propulsion system.

To this end, according to a first aspect, there is proposed an aeronautical propulsion system comprising:
a fan rotor connected to a fan shaft;
a first spool comprising a first turbine configured to drive the fan rotor via a first shaft;
a second spool comprising a second turbine and a second axial compressor, the second turbine being a two-stage turbine and being configured to drive the second compressor via a second shaft, the second shaft being configured to rotate at a higher speed than the first shaft and a hub-to-tip ratio at the inlet of the second compressor being comprised between 0.41 and 0.60;
a reduction mechanism coupling the first shaft and the fan shaft in order to drive the fan shaft at a rotation speed lower than the rotation speed of the first shaft;
   wherein the second spool meets the following formula:

$$( E * {n}_{5} + F ) < \frac{{R}_{ext \_ 5}}{{R}_{ext \_ 7}} < ( E * {n}_{5} + G )$$

where: R_{ext_5} is the average outer radius of the second compressor in millimeters (mm);
   R_{ext_7} is the average outer radius of the second turbine, in millimeters (mm);
   n₅ is the number of stages in the second compressor; and
   E=−23.9*10⁻³ square millimeters (mm²), F=0.96 and G=1.06.

Some preferred but non-limiting characteristics of the propulsion system according to the first aspect are the following, taken individually or in combination:
the average outer radius of the second compressor meets the following formula:

$${R}_{ext \_ 5} < \sqrt{A * \frac{{D}_{9}^{2}}{B P R + 1} * \frac{Te}{( 572 * {N}^{2} * {S}_{7} ) 1 {0}^{- 12} - B}}$$

where: D₉ is the diameter of the fan rotor in millimeters, measured in a plane normal to an axis of rotation of the fan rotor at an intersection between a tip and a leading edge of the blades of the fan rotor; BPR is the bypass ratio of the propulsion system and is measured when the propulsion system is stationary in take-off rating in a standard atmosphere and at sea level; Tₑ is the maximum inlet temperature of the first turbine when the propulsion system is stationary in take-off rating in a standard atmosphere and at sea level and is expressed in degrees Celsius (° C.); N is the rotation speed of the second shaft and is measured when the propulsion system is stationary in take-off rating in a standard atmosphere and at sea level, in revolutions per minute (rpm); S₇ is an average surface of the second turbine expressed in square millimeters (mm²); and A=1 (rpm)²·mm/° C. and B=8,977 (rpm)²*mm². the average outer radius of the second compressor meets the following formula:

$${R}_{ext \_ 5} > \sqrt{A * \frac{{D}^{2}}{B P R + 1} * \frac{Te}{( 572 * {N}^{2} * {S}_{7} ) 1 {0}^{- 12} - C}}$$

where: D₉ is the diameter of the fan rotor in millimeters, measured in a plane normal to an axis of rotation of the fan rotor at an intersection between a tip and a leading edge of the blades of the fan rotor; BPR is the bypass ratio of the propulsion system and is measured when the propulsion system is stationary in take-off rating in a standard atmosphere and at sea level; Tₑ is the maximum inlet temperature of the first turbine when the propulsion system is stationary in take-off rating in a standard atmosphere and at sea level and is expressed in degrees Celsius (° C.); N is the rotation speed of the second shaft and is measured when the propulsion system is stationary in take-off rating in a standard atmosphere and at sea level; in revolutions per minute (rpm); S₇ is an average surface of the second turbine expressed in square millimeters (mm²); and C=7,668 (rpm)²*mm²;
the second turbine is a two-stage turbine and the second compressor is axial;
the second compressor comprises at least eight stages and at most eleven stages;
the diameter of the fan rotor is comprised between 2,032 mm and 4,699 mm inclusive, for example between 2,159 mm and 3,048 mm inclusive, for example of the order of 2,286 mm;
the fan section is ducted and a bypass ratio of the propulsion system is greater than or equal to 10, for example comprised between 10 and 35 inclusive, for example between 10 and 18 inclusive;
the fan section is unducted and a bypass ratio of the propulsion system is greater than or equal to 40, for example comprised between 40 and 80 inclusive;
the rotation speed of the second shaft is greater than or equal to 15,000 revolutions per minute and less than or equal to 27,000 revolutions per minute;
an overall compression ratio of the propulsion system, corresponding to the ratio between an outlet pressure of the second compressor and an inlet pressure of the fan rotor, is greater than or equal to 40 and less than or equal to 70;
the first turbine comprises at least three and at most five stages;
the first turbine further drives a first compressor via the first shaft, the first compressor comprising at least two and at most four stages;
a compression ratio of the second compressor is greater than or equal to 18; and/or
the fan section further has a fan pressure ratio, corresponding to a pressure ratio between an outlet of the fan rotor and an inlet of the fan rotor less than or equal to 1.45, for example less than or equal to 1.30.

According to a second aspect, there is proposed an aircraft comprising at least one propulsion system according to the first aspect, fixed to the aircraft via a mast.

According to a third aspect, there is proposed a method for dimensioning or manufacturing a propulsion system comprising a reduction mechanism coupling a first turbine of a first spool and a fan rotor to drive the fan rotor at a lower speed than a speed of the first turbine, and a second spool comprising a second two-stage turbine and a second axial compressor configured to rotate at a higher speed than the first turbine, a hub-to-tip ratio at the inlet of the second compressor (5) being comprised between 0.41 and 0.60, in which the second spool is dimensioned so as to meet the following formula:

$$( E * {n}_{5} + F ) < \frac{{R}_{ext \_ 5}}{{R}_{ext \_ 7}} < ( E * {n}_{5} + G )$$

where: R_{ext_5} is an average outer radius of the second compressor in millimeters (mm);
   R_{ext_7} is an average outer radius of the second turbine, in millimeters (mm);
   n₅ is the number of stages in the second compressor; and
   E=−23.9*10⁻³ square millimeters (mm²), where F=0.96 and G=1.06

Some preferred but non-limiting characteristics of the dimensioning or manufacturing method according to the third aspect are the following, taken individually or in combination:
the second compressor is further dimensioned such that the average outer radius of the second compressor meets the following formula:

$${R}_{ext \_ 5} > \sqrt{A * \frac{{D}^{2}}{B P R + 1} * \frac{Te}{( 572 * {N}^{2} * {S}_{7} ) 1 {0}^{- 12} - B}}$$

where: D₉ is the diameter of the fan rotor in millimeters, measured in a plane normal to an axis of rotation of the fan rotor at an intersection between a tip and a leading edge of the blades of the fan rotor; BPR is the bypass ratio of the propulsion system and is measured when the propulsion system is stationary in take-off rating in a standard atmosphere and at sea level; Tₑ is the maximum inlet temperature of the first turbine when the propulsion system is stationary in take-off rating in a standard atmosphere and at sea level and is expressed in degrees Celsius (° C.); N is the rotation speed of the second shaft and is measured when the propulsion system is stationary in take-off rating in a standard atmosphere and at sea level; in revolutions per minute (rpm); S₇ is an average surface of the second turbine expressed in square millimeters (mm²); and A=1 (rpm)²·mm/° C. and B=8,977 (rpm)²*mm².
the second compressor is further dimensioned such that the average outer radius of the second compressor meets the following formula:

$${R}_{ext \_ 5} < \sqrt{A * \frac{{D}^{2}}{B P R + 1} * \frac{Te}{( 572 * {N}^{2} * {S}_{7} ) 1 {0}^{- 12} - C}}$$

where: D₉ is the diameter of the fan rotor in millimeters, measured in a plane normal to an axis of rotation of the fan rotor at an intersection between a tip and a leading edge of the blades of the fan rotor; BPR is the bypass ratio of the propulsion system and is measured when the propulsion system is stationary in take-off rating in a standard atmosphere and at sea level; Tₑ is the maximum inlet temperature of the first turbine when the propulsion system is stationary in take-off rating in a standard atmosphere and at sea level and is expressed in degrees Celsius (° C.); N is the rotation speed of the second shaft and is measured when the propulsion system is stationary in take-off rating in a standard atmosphere and at sea level, in revolutions per minute (rpm); S₇ is an average surface of the second turbine expressed in square millimeters (mm²); and C=7,668 (rpm)²*mm²; and/or
the second compressor is further dimensioned such that a compression ratio of the second compressor is greater than or equal to 18.

According to a fourth aspect, there is proposed a method for manufacturing a propulsion system comprising the following steps:
dimensioning the propulsion system according to one method in accordance with the third aspect; and
manufacturing the propulsion system.

### DESCRIPTION OF THE FIGURES

Other characteristics, aims and advantages will emerge from the following description, which is purely illustrative and non-limiting, and which should be read in relation to the appended drawings, in which:

FIG. 1 is a schematic, partial and sectional view of one example of a propulsion system in accordance with a first embodiment, in which the fan section is ducted;

FIG. 2 is a schematic, partial and sectional view of one example of a propulsion system in accordance with a first embodiment, in which the fan section is unducted;

FIG. 3 is a schematic sectional view of one example of a reduction mechanism according to a first variant;

FIG. 4 is a schematic sectional view of one example of a reduction mechanism according to a second variant;

FIG. 5 is one example of an aircraft that may comprise at least one propulsion system in accordance with the first or second embodiment;

FIG. 6 is a flowchart illustrating examples of steps in a dimensioning or manufacturing method in accordance with one embodiment.

Throughout the figures, similar elements bear identical references.

### DETAILED DESCRIPTION

A propulsion system 1 has a main direction extending along a longitudinal axis X and comprises, from upstream to downstream in the direction of gas flow in the propulsion system 1 when in operation, a fan section 2 and a primary spool 3, often called “gas generator”, including a compressor section 4, 5, a combustion chamber 6 and a turbine section 7, 8. The propulsion system 1 is here an aeronautical propulsion system 1 configured to be fixed to an aircraft 100 via a pylon (or mast).

The compressor section 4, 5 comprises a succession of stages each comprising a blade wheel (rotor) 4a, 5a rotating in front of a vane wheel (stator) 4b, 5b. The turbine section 7, 8 also comprises a succession of stages, each comprising a vane wheel (stator) 7b, 8b, behind which a blade wheel (rotor) 7a, 8a rotates.

In the present application, the axial direction corresponds to the direction of the longitudinal axis X, in correspondence with the rotation of the gas generator shafts, and a radial direction is a direction perpendicular to this axis X and passing therethrough. Moreover, the circumferential (or lateral or tangential) direction corresponds to a direction perpendicular to the longitudinal axis X and not passing therethrough. Unless otherwise specified, the terms “inner” (respectively, internal) and “outer” (respectively, external), respectively, are used with reference to a radial direction so that the inner portion or face of an element is closer to the axis X than the outer portion or face of the same element.

In operation, an air stream F entering the propulsion system 1 is divided between a primary air stream F1 and a secondary air stream F2, which circulate from upstream to downstream in the propulsion system 1.

The secondary air stream F2 (also called “bypass air stream”) flows around the primary spool 3. The secondary air stream F2 cools the periphery of the primary spool 3 and serves to generate most of the thrust provided by the propulsion system 1.

The primary air stream F1 flows in a primary path inside the primary spool 3, passing successively through the compressor section 4, 5, the combustion chamber 6 where it is mixed with fuel to serve as an oxidizer, and the turbine section 7, 8. The passage of the primary air stream F1 through the turbine section 7, 8 receiving energy from the combustion chamber 6 causes rotation of the rotor of the turbine section 7, 8, which in turn drives in rotation the rotor of the compressor section 4, 5 as well as a rotor portion 9 of the fan section 2.

In a two-spool propulsion system 1, the compressor section 4, 5 may comprise a low-pressure compressor 4 and a high-pressure compressor 5. The turbine section 7, 8 may comprise a high-pressure turbine 7 and a low-pressure turbine 8. The rotor of the high-pressure compressor 5 is driven in rotation by the rotor of the high-pressure turbine 7 via a high-pressure shaft 10. The rotor of the low-pressure compressor 4 and the rotor portion 9 of the fan section 2 are driven in rotation by the rotor of the high-pressure turbine 8 via a low-pressure shaft 11. Thus, the primary spool 3 comprises a high-pressure spool comprising the high-pressure compressor 5, the high-pressure turbine 7 and the high-pressure shaft 10, and a low-pressure spool comprising the fan section 2, the low-pressure compressor 4, the high-pressure turbine 8 and the low-pressure shaft 11. The rotation speed of the high-pressure spool is greater than the rotation speed of the low-pressure spool. In a triple-spool propulsion system 1, the turbine section 7, 8 further comprises an intermediate turbine, positioned between the high-pressure turbine 7 and the high-pressure turbine 8 and configured to drive the rotor of the low-pressure compressor 4 via an intermediate shaft. The fan rotor 9 and the rotor of the high-pressure compressor 5 remain driven by the low-pressure shaft 11 and the high-pressure shaft 10, respectively.

The low-pressure shaft 11 is generally housed, over a part of its length, in the high-pressure shaft 10 and is coaxial with the high-pressure shaft 10. The low-pressure shaft 11 and the high-pressure shaft 10 may be co-rotating, that is to say driven in the same direction about the longitudinal axis X. As a variant, the low-pressure shaft 11 and the high-pressure shaft are counter-rotating, that is to say driven in opposite directions about the longitudinal axis X. Where appropriate, the intermediate shaft is housed between the high-pressure shaft 10 and the low-pressure shaft 11. The intermediate shaft and the low-pressure shaft 11 may be co-rotating or counter-rotating.

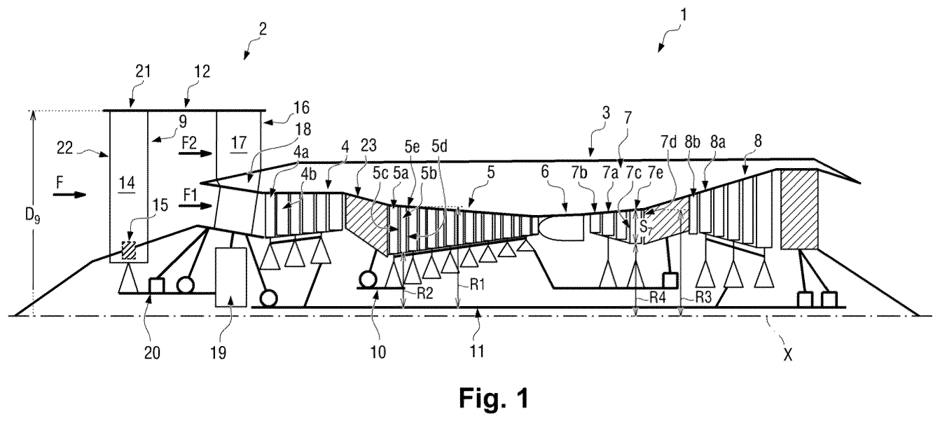

The fan section 2 comprises at least the fan rotor 9 capable of being driven in rotation relative to a stator portion of the propulsion system 1 by the turbine section 7, 8. Each fan rotor 9 comprises a hub 13 and blades 14 extending radially from the hub 13. The blades 14 of each rotor 9 may be fixed relative to the hub 12 or have a variable setting. In this case, the root of the blades 14 of each rotor 9 is pivotally mounted along a setting axis and is connected to a pitch change mechanism 15 mounted in the propulsion system 1, the setting being adjusted according to the flight phases by a pitch change mechanism 15. The pitch change mechanism 15 is illustrated in broken lines in FIG. 1 to show that this characteristic is optional.

The fan section 2 may further comprise a fan stator 16, or straightener, which comprises vanes 17 mounted on a hub 18 of the fan stator 16 and have the function of straightening the secondary air stream F2 which flows at the outlet of the fan rotor 9. The vanes 17 of the fan stator 18 may be fixed relative to the hub 18 or have a variable setting. Similarly to the rotor blades 14, the root of the stator blades 17 is pivotally mounted along a setting axis X and is connected to a pitch change mechanism 15a, which is generally distinct from that of the fan rotor 9, the setting being adjusted according to the flight phases by the pitch change mechanism.

The fan rotor 9 moreover comprises at least twelve blades 14 and at most twenty-four blades 14, for example at least sixteen blades 14 and at most twenty-two blades 14. The number of vanes 16 in the fan stator 17 depends on the acoustic criteria defined for the propulsion system 1 and is at least equal to the number of blades 14.

In order to improve the propulsive efficiency of the propulsion system 1 and to reduce its specific consumption as well as the noise emitted by the fan section 2, the propulsion system 1 has a high bypass ratio. By high bypass ratio, it is meant here a bypass ratio greater than or equal to 10, for example comprised between 10 and 80 inclusive. To calculate the bypass ratio, the mass flow rate of the secondary air stream F2 and the mass flow rate of the primary air stream F1 are measured when the propulsion system 1 is stationary, uninstalled, in take-off rating in a standard atmosphere (as defined by the International Civil Aviation Organization (ICAO) manual, Doc 7488/3, 3^{rd} edition) and at sea level (conditions known as SLS, for Seal Level Standard). It should be noted that, in the present application, the parameters (pressure, flow rate, thrust, speed, etc.) are systematically determined under these conditions. By “uninstalled” it will be meant here that the measurements are performed when the propulsion system 1 is in a test bench (and uninstalled on an aircraft 100), the measurements then being simpler to make. The distances (length, radius, diameter, etc.) are however measured at room temperature (around 20° C.) when the propulsion system 1 is cold, that is to say when the propulsion system is stopped from a sufficient period for the parts of the propulsion system to be at room temperature, it being understood that these dimensions vary little compared to the conditions in which the propulsion system 1 is in take-off rating.

The fan rotor 9 is decoupled from the low-pressure shaft 11 using a reduction mechanism 19, placed between an upstream end of the low-pressure shaft 11 and the fan rotor 9, in order to independently optimize their respective rotation speed. In this case, the propulsion system 1 further comprises an additional shaft, called fan shaft 20. The low-pressure shaft 11 connects the high-pressure turbine 8 to an inlet of the reduction mechanism 19 while the fan shaft 20 connects the outlet of the reduction mechanism 19 to the fan rotor 9. The fan rotor 9 is therefore driven by the low-pressure shaft 11 via the reduction mechanism 19 and the fan shaft 20 at a rotation speed lower than the rotation speed of the high-pressure turbine 8.

This decoupling makes it possible to reduce the rotation speed and the pressure ratio of the fan rotor 9 and to increase the power extracted by the high-pressure turbine 8. Indeed, the overall efficiency of the propulsion systems is conditioned to the first order by the propulsive efficiency, which is favorably influenced by minimizing the variation of the kinetic energy of the air at the crossing of the propulsion system 1. In a propulsion system 1 with a high bypass ratio, most of the flow rate generating the propulsive force is constituted by the secondary air stream F2 of the propulsion system 1, the kinetic energy of the secondary air stream F2 being mainly affected by the compression that the secondary air stream F2 undergoes during the crossing of the fan section 2. The propulsive efficiency and the pressure ratio of the fan section 2 are therefore linked: the lower the pressure ratio of the fan section 2, the better the propulsive efficiency. In order to optimize the propulsive efficiency of the propulsion system 1, the pressure ratio of the fan, which corresponds to the ratio between the average outlet pressure of the fan stator 17 (or, in the absence of a stator, of the fan rotor 9) and the average inlet pressure of the fan rotor 9, is less than or equal to 1.70, for example less than or equal to 1.50, for example comprised between 1.05 and 1.45. The average pressures are measured here over the height of the blade 14 (from the surface which radially delimits, inside, the flow path at the inlet of the fan rotor 9 to the tip 21 of the fan blade 14).

The propulsion system 1 is configured to provide a thrust comprised between 18,000 lbf (80,068 N) and 51,000 lbf (22 2411 N), for example between 20,000 lbf (88,964 N) and 35,000 lbf (15 5688 N).

The fan section 2 can be ducted or unducted. In the case of a ducted fan section 2, the fan section 2 comprises a fan casing 12 and the fan rotor 9 is housed in the fan casing 12.

A ducted fan section 2 comprises a fan rotor 9 extending upstream of a fan stator 16. The vanes 17 of the fan stator 16 are then generally referred to as outlet guide vanes (OGV) and have a fixed setting relative to the hub of the fan stator. Moreover, the peripheral speed at the tip 21 of the blades of the fan rotor 9 may also be comprised between 260 m/s and 400 m/s. The blades 14 of the fan rotor 9 may be fixed or have a variable setting

In an unducted fan section 2, the fan section 2 is not surrounded by a fan casing. Since the fan section 2 is unducted, the blades 14 of the fan rotor 9 have a variable setting. Propulsion systems comprising at least one unducted fan rotor 9 are known as “open rotor” or “unducted fan”. The propulsion system 1 may comprise two unducted and counter-rotating fan rotors 9. Such a propulsion system 1 is known as CROR for “Contra-Rotating Open Rotor” or UDF for “Unducted Double Fan”. The fan rotor(s) 9 may be placed at the rear of the primary spool 3 so as to be of the pusher type or at the front of the primary spool 3 so as to be of the tractive type. As a variant, the propulsion system 1 may comprise a single unducted fan rotor 9 and an unducted fan stator 16 (straightener). Such a propulsion system 1 is known as USF for “Unducted Single Fan”. In the case of a USF-type propulsion system 1, the vanes 17 of the straightener 16 are fixed in rotation relative to the axis of rotation X of the upstream fan rotor 9 and therefore do not undergo a centrifugal force. The vanes 17 of the straightener 16 are also variable-setting vanes.

The removal of the fairing around the fan section 2 makes it possible to increase the bypass ratio very significantly without the propulsion system 1 being penalized by the mass of the casings or nacelles intended to surround the fan section 2. The peripheral speed at the tip 21 of the blades 14 of the fan rotor(s) 9 can also be comprised between 210 m/s and 260 m/s.

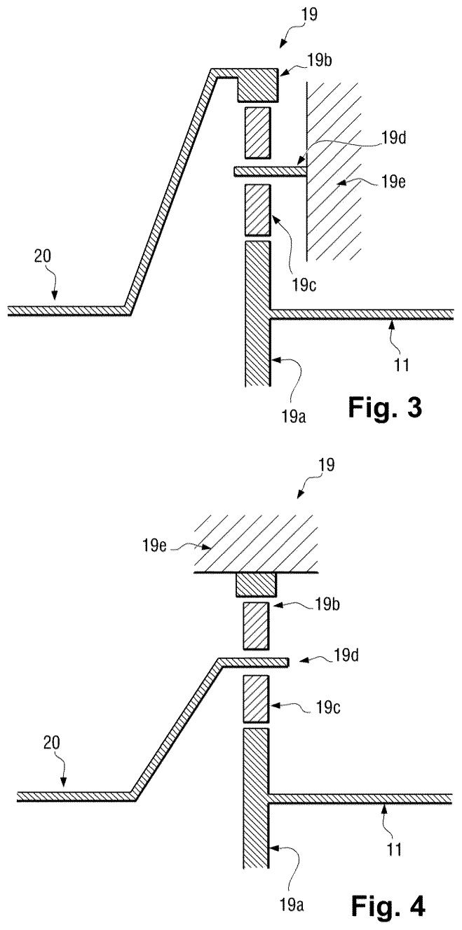

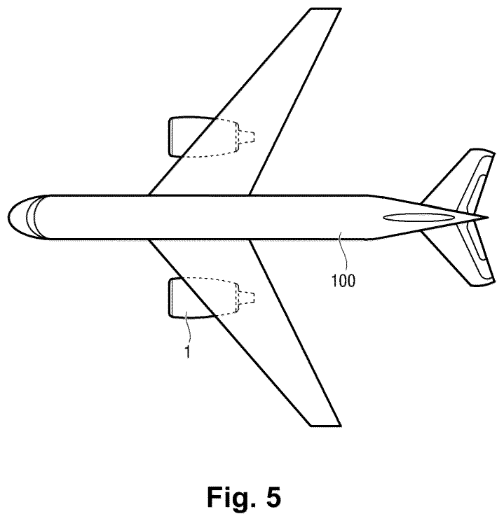

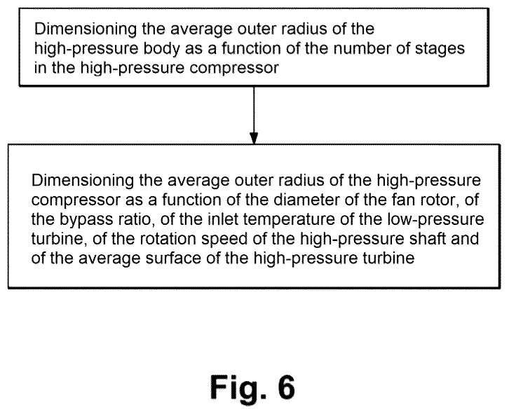

The reduction mechanism 19 may comprise for example a reduction mechanism with a planetary gear train, for example of the “planetary” type or “star” type, according to the encountered terminology of those skilled in the art, single-staged or two-staged. According to a first variant, the reduction mechanism 19 may be of the star type (FIG. 3) and comprise a sun gear pinion 19a (inlet of the reduction mechanism 19), centered on an axis of rotation X of the reduction mechanism 19 (generally coincident with the longitudinal axis X) and configured to be driven in rotation by the low-pressure shaft 11, a ring gear 19b (outlet of the reduction mechanism 19) coaxial with the sun gear pinion 19a and configured to drive in rotation the fan shaft 20 about the axis of rotation X, and a series of planet gears 19c circumferentially distributed about the axis of rotation X between the sun gear pinion 19a and the ring gear 19b, each planet gear 19c being meshed internally with the sun gear pinion 19a and externally with the ring gear 19b. The series of planet gears 19c is mounted on a planet gear carrier 19d which is fixed relative to a stator portion 19e of the propulsion system 1, for example relative to a casing of the compressor section 4, 5. According to a second variant, the reduction mechanism 19 can be of the “planetary” type (FIG. 4), in which case the ring gear 19b is fixedly mounted on the stator portion 19e of the propulsion system 1 and the fan shaft 20 is driven in rotation by the planet gear carrier 19d (which is therefore movable in rotation relative to a stator portion 19e of the propulsion system 1, for example relative to a casing of the compressor section 4, 5).

Regardless of the configuration of the reduction mechanism 19, the diameter of the ring gear 19b and of the planet gear carrier 19d are greater than the diameter of the sun gear pinion 19a, such that the rotation speed of the fan rotor 9 is lower than the rotation speed of the low-pressure shaft 11.

The reduction ratio of the reduction mechanism 19 is greater than or equal to 2.5 and less than or equal to 11. In the case of a propulsion system 1 comprising a ducted fan rotor 9, the reduction rate can be greater than or equal to 2.7 and less than or equal to 6.0, for example around 3.0. In the case of a propulsion system 1 comprising an unducted fan rotor, the reduction ratio can be comprised between 9.0 and 11.0.

The redline speed of the low-pressure shaft 11, which corresponds to the absolute maximum speed likely to be encountered by the low-pressure shaft 11 during the entire flight (according to the European certification regulation EASA CS-E 740 (or according to the American certification regulation 14-CFR Part 33) is comprised between 8,500 revolutions per minute and 12,000 revolutions per minute, for example between 9,000 revolutions per minute and 11,000 revolutions per minute. The redline speed corresponds to the maximum rotation speed when the propulsion system is sound (and potentially at the end of its life). It is therefore likely to be reached by the low-pressure shaft 11 in flight conditions. This redline speed forms part of the data declared in the engine certification (type certificate data sheet). Indeed, this rotation speed is usually used as a reference speed for the dimensioning of the propulsion systems 1 and in some certification tests (such as blade loss or rotor integrity tests).

In order to optimize the performances of the propulsion system 1, particularly its radial footprint, the high-pressure turbine 7 is a two-stage turbine and the high-pressure spool meets the following formula:

$$\frac{{R}_{ext \_ 5}}{{R}_{ext \_ 7}} < ( E * {n}_{5} + G ) \qquad ( 1 )$$

where: R_{ext_5} is the average outer radius of the high-pressure compressor, in millimeters (mm);
   R_{ext_7} is the average outer radius of the high-pressure turbine 7, in millimeters (mm);
   n₅ is the number of stages in the high-pressure compressor 5; and
   E=−23.9*10⁻³ square millimeters (mm²) and G=1.06 (dimensionless).

The average outer radius R_{ext_5} of the high-pressure compressor 5 is equal to the arithmetic mean of the outer radii R1 of all the rotors (blade wheels) of the high-pressure compressor 5. In a given stage, the outer radius R1 of the rotor 7b corresponds to the distance between the tip 5e of the blades of the rotor 5a and the axis of rotation X, midway (at the tip 5e) between the leading edge 5c and the trailing edge 5d of the blades of the rotor 5a (50% of the chord at the tip 5e). When the high-pressure compressor 5 comprises a spinning wheel (entirely or partly centrifugal compressor), then the spinning wheel counts as two stages in the calculation of the number of stages n₅ of the high-pressure compressor 5.

The average outer radius R_{ext_7} of the high-pressure turbine 7 is equal to the arithmetic mean of the outer radii R3 of the rotors 7b (blade wheels) of the high-pressure turbine 7. In a given stage, the outer radius R3 of the rotor corresponds to the distance between the tip 7e of the blades of the rotor 7b and the axis of rotation X, midway (at the tip 7e) between the leading edge 7c and the trailing edge 7d of the blades of the rotor 7b (50% of the chord at the tip 7e).

As previously indicated, the average outer radii R_{ext_5} and R_{ext_7} are determined when the propulsion system 1 is cold.

For the same number of stages, the compliance with the formula (1) makes it possible to obtain a more radially compact high-pressure compressor 5 without penalizing its efficiency. Indeed, the smaller the average outer radius R_{ext_5} of the high-pressure compressor 5, the more the high-pressure compressor 5 is compact. The reduction of the average outer radius R_{ext_5} certainly has the effect of increasing the aerodynamic load of the high-pressure compressor 5 (and therefore of reducing its efficiency): however, the formula (1) makes it possible to reach an acceptable compromise between the radial compactness and the efficiency of the high-pressure compressor 5, and to gain in mass and specific consumption of the propulsion system 1. In addition, the formula (1) taking into account the average outer radius R_{ext_7} of the high-pressure turbine 7, the mechanical loading of the high-pressure turbine 7 (which is proportional to the product of the squared rotation speed of the high-pressure shaft 10 and the average surface S₇ of the high-pressure turbine 7) remains acceptable. Finally, the high-pressure turbine 7 being a two-stage turbine makes it possible to optimize the aerodynamic load per stage.

The average outer radius R_{ext_5} of the high-pressure compressor may for example be comprised between 170 and 250 millimeters (mm) for a compressor comprising between 8 and 11 stages, with a maximum rotational speed (redline speed) in SLS conditions between 18,000 and 28,000 rpm.

The average outer radius R_{ext_7} of the high-pressure turbine 7 may for example be comprised between 200 and 300 millimeters (mm) under the same conditions.

The compression ratio of the high-pressure compressor 5 is preferably greater than or equal to 18, when the propulsion system is in cruising condition, that is to say at an altitude of 10,668 m (35,000 feet), 0.8 Mach and in ISA (International Standard Atmosphere) conditions defined by the standard ISO 2533/1975 edition/1985 addendum.

In one embodiment, the high-pressure spool may further meet the following formula:

$$\frac{{R}_{ext \_ 5}}{{R}_{ext \_ 7}} > ( E * {n}_{5} + F ) \qquad ( 2 )$$

where F=0.96 (dimensionless).

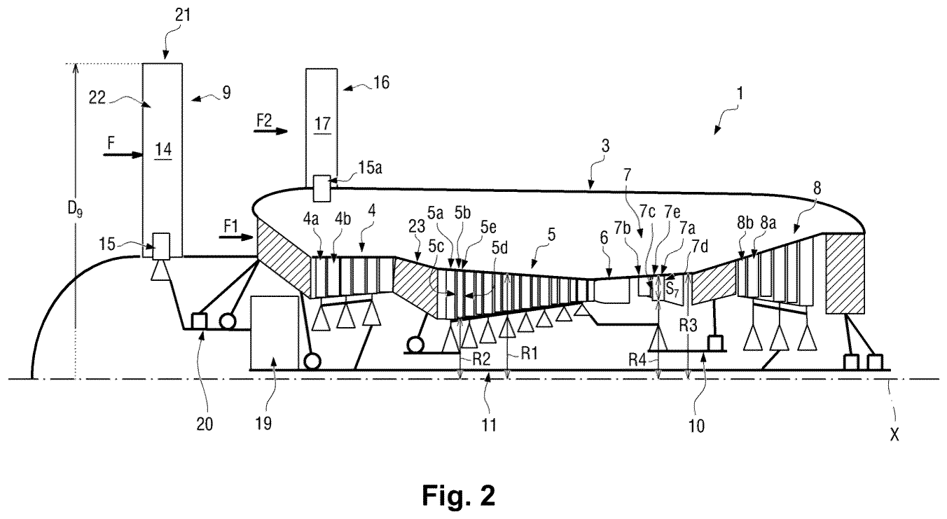

In this way, the aerodynamic load of the high-pressure compressor 5 remains low enough to ensure sufficient efficiency of the high-pressure compressor 5, with an optimized radial footprint of the high-pressure spool.

Where appropriate, in order to further optimize the performances of the propulsion system 1, particularly its footprint and its overall dynamics, the average outer radius R_{ext_5} of the high-pressure compressor 5 can meet the following formula:

$${R}_{ext \_ 5} < \sqrt{A * \frac{{D}^{2}}{B P R + 1} * \frac{Te}{( 572 * {N}^{2} * {S}_{7} ) 1 {0}^{- 12} - B}} \qquad ( 3 )$$

where: D₉ is the diameter of the fan rotor 9 in millimeters (mm), measured in a plane normal to the axis of rotation X at an intersection between a tip 21 and a leading edge 22 of the blades 14 of the fan rotor 9. It should be noted that since FIGS. 1 and 2 are partial views, the diameter D₉ is only partially visible;
   BPR is the bypass ratio of the propulsion system 1;
   Tₑ is the maximum inlet temperature of the low-pressure turbine 8 in degrees Celsius (° C.);
   N is the rotation speed of the high-pressure shaft 10, in revolutions per minute (rpm);
   S₇ is an average surface of the high-pressure turbine 7 in square millimeters (mm²); and
   A=1 (rpm)²·mm/° C. and B=8,977 (rpm)²*mm².

The average surface S₇ of the high-pressure turbine 7 is equal to the arithmetic mean of the flow path surfaces at 50% of the chord at the tip 7e of all the rotors 7b (blade wheels) of the high-pressure turbine 7. The surface of the flow path of a given rotor 7b of the high-pressure turbine 7 is equal to π×(R_{ext_7}²−R_{int_7}²),²), where R_{int_7} corresponds to the average inner radius of the high-pressure turbine 7. The average inner radius R_{int_7} of the high-pressure turbine 7 is equal to the arithmetic mean of the inner radii R4 of the rotors 7b (blade wheels) of the high-pressure turbine 7. In a given stage, the inner radius R4 of the rotor corresponds to the distance between the axis of rotation X and the surface which radially delimits, inside, the flow path in the rotor 7b, in a plane passing through 50% of the chord at the tip 7e, so that the outer R3 and inner R4 radii are measured in the same plane.

As previously indicated, the bypass ratio BPR, the temperature Tₑ and the rotation speed N are determined under take-off condition. The average outer radius R_{ext_5} and the diameter D₉ are on the other hand determined when the propulsion system 1 is cold.

The inlet temperature Tₑ of the low-pressure turbine can be comprised between 950° C. and 1,230° C.

When the average outer radius R_{ext_5} meets the formula (3), the radial and longitudinal footprint of the high-pressure compressor 5 and the mass of the high-pressure compressor 5 are reduced, with similar performances. Indeed, the power density of the high-pressure compressor 5 is proportional to the ratio between the inlet flow rate of the low-pressure compressor 4 and the inlet temperature Tₑ of the low-pressure turbine 8, knowing that the inlet flow rate of the low-pressure compressor 4 is a function of the bypass ratio BPR of the propulsion system 1 and of the diameter D₉ of the fan rotor 9 (for the same ratio D/S, where S corresponds to the inlet section of the fan rotor 9). Thus, by dimensioning the average outer radius R_{ext_5} as a function of the fan diameter D₉ and of the bypass ratio BPR, it is possible to reduce the average outer radius of the high-pressure compressor 5 while guaranteeing that the power density of the high-pressure compressor 5 is sufficient to obtain an efficient propulsion system 1 (and therefore has good energy performances).

The average outer radius R_{ext_5} is also dimensioned by taking into account the mechanical load of the high-pressure turbine 7 (via the average surface S₇ of the high-pressure turbine 7), so that the formula (1) makes it possible to reduce both the footprint and the mass of the high-pressure spool, without mechanically penalizing the high-pressure turbine 7 or affecting the efficiency of the propulsion system 1. The reduction of the radial footprint of the high-pressure compressor 5 also makes it possible to facilitate the integration of the propulsion system 1 into an aircraft 100 and to reduce its drag.

This optimization of the average outer radius (R_{ext_5}) of the high-pressure compressor 5 can in particular be obtained by increasing the bypass ratio BPR of the propulsion system 1 and by reducing the pressure ratio of the fan rotor 9, and therefore by improving the efficiency of the propulsion system 1. For a ducted fan section 2, the bypass ratio BPR of the propulsion system 1 can then be greater than or equal to 10, for example comprised between 10 and 35 inclusive, for example between 10 and 18 inclusive. The fan pressure ratio can also be comprised between 1.20 and 1.45. For an unducted fan section 2, the bypass ratio BPR of the propulsion system 1 can be greater than or equal to 40, for example comprised between 40 and 80 inclusive. The fan pressure ratio can then be comprised for example between 1.05 and 1.20.

Alternatively or additionally, this reduction can be obtained by improving the aerodynamic performances of the high-pressure spool, by increasing the admissible Mach for the same efficiency for the same aerodynamic load and/or by increasing the aerodynamic load for the same efficiency (with a compensation possibly by reduction of the Mach in the path of the high-pressure compressor 5), in order to increase the power of the high-pressure turbine 7 and its mechanical resistance. For example, the reduction of the leaks in the high-pressure turbine 7 (by maintaining the clearances) makes it possible to increase the efficiency of the compression made in the high-pressure compressor 5 and of the expansion in the high-pressure turbine 7.

When the average outer radius (R_{ext_5}) meets the formula (3), the high-pressure turbine 7 can also rotate at sufficiently high rotation speeds (in revolutions per minute) (and at acceptable mechanical loading) to allow the high-pressure compressor 5 to reach a high-power density and a compression ratio greater than 21 (in take-off rating) without requiring an increase in the number of stages in the high-pressure compressor 5 (and thus by limiting its longitudinal footprint). The rotation speed of the high-pressure shaft 10 can then be comprised between 15,000 revolutions per minute and 27,000 revolutions per minute. The high-pressure compressor 5 may be axial, the high-pressure compressor 5 being able to comprise at least eight stages and at most eleven stages, for example nine stages.

An overall compression ratio of the propulsion system 1 is further obtained, which corresponds to the pressure ratio between the outlet pressure of the high-pressure compressor 5 and the inlet pressure of the fan rotor 9 (measured at the root of the fan rotor 9), and which can be greater than or equal to 40 and less than or equal to 70, for example greater than or equal to 44 and less than or equal to 55.

For example, the average outer radius R_{ext_5} also meets the following formula:

$${R}_{ext \_ 5} > \sqrt{A * \frac{{D}^{2}}{B P R + 1} * \frac{Te}{( 572 * {N}^{2} * {S}_{7} ) 1 {0}^{- 12} - C}} \qquad ( 4 )$$

where: C=7,668 (rpm)²*mm².

When the average outer radius R_{ext_5} also meets the formula (4), the high-pressure compressor 5 remains large enough to compress the air at the inlet of the combustion chamber 6 and thus contribute to the overall compression ratio of the propulsion system 1. In addition, the aerodynamic load and the Mach in the flow path remain compatible with efficiency and operability objectives for the high-pressure compressor 5.

For a high-pressure compressor 5 whose average outer radius R_{ext_5} meets the formula (1) (and, where appropriate, the formulas (2), (3) and/or (4)), the diameter D₉ of the fan rotor can then be comprised between 2,032 mm (80 inches) and 4,699 mm (185 inches) inclusive. When the fan rotor 9 is ducted, the diameter D₉ is for example comprised between 2,159 mm (85 inches) and 3,048 mm (120 inches) inclusive, for example of the order of 2,286 mm (90 inches), which allows the integration of the propulsion system 1 in a conventional manner, particularly under the wing of an aircraft. When the fan rotor 9 is unducted, the diameter D₉ is for example greater than or equal to 2,540 mm (100 inches), for example between 3,048 cm (120 inches) and 3,962 mm (156 inches).

High-pressure spools meeting the formula (1) and where appropriate the formulas (2), (3) and/or (4) may comprise a high-pressure compressor 5 having a hub-to-tip ratio at the inlet of the high-pressure compressor 5, which corresponds to the ratio between the outer radius R1 of the high-pressure compressor 5 and the inner radius R2 of the rotor 5b of the high-pressure compressor 5, comprised between 0.41 and 0.60.

The outer radius R1 and the inner radius R2 are measured here in a plane normal to the axis of rotation X which intersects the leading edge and the blade root of the most upstream rotor 5b of the high-pressure compressor 5 (that is to say of the first stage of the high-pressure compressor 5). The inner radius R2 of the high-pressure compressor 5 corresponds to the distance, in this plane, between the outer radial surface of the hub of the rotor 5b (which radially delimits, inside, the flow path in the rotor 5b) and the axis of rotation X.

Such high-pressure compressors 5 then have an optimized outlet section. Indeed, the smaller the hub-to-tip ratio, the smaller the outer diameter of the high-pressure compressor 5 (for the same section). A hub-to-tip ratio comprised between 0.41 and 0.60, in combination with a ratio between the optimized average outer radii of the high-pressure compressor 5 R_{ext_5} and high-pressure turbine 7 R_{ext_7} as described above, thus not only makes it possible to obtain a more radially compact high-pressure compressor 5 with a surface adapted to compress the gases at the inlet of the combustion chamber 6, but also to maintain a suitable aerodynamic load.

For a high-pressure compressor 5 whose average outer radius R_{ext_5} meets the formula (1) (and where appropriate the formula (2)), the diameter D₉ of the fan rotor may then be comprised between 2,032 mm (80 inches) and 4,699 mm (185 inches) inclusive. When the fan rotor 9 is ducted, the diameter D₉ is for example comprised between 2,159 mm (85 inches) and 3,048 mm (120 inches) inclusive, for example of the order of 2,286 mm (90 inches), which allows the integration of the propulsion system 1 in a conventional manner, particularly under the wing of an aircraft. When the fan rotor 9 is unducted, the diameter D₉ is for example greater than or equal to 2,540 mm (100 inches), for example between 3,048 cm (120 inches) and 3,962 mm (156 inches).

A two-spool propulsion system 1 having an average outer radius R_{ext_5} in the intervals defined above may in particular comprise a high-pressure turbine 8 comprising at least three stages and at most five stages and a low-pressure compressor 4 comprising at least two stages and at most four stages.

### Comparative Example

Engine 1 is a propulsion system corresponding to the current technical standard (at the filing date of the present application) sought to be improved which comprises a ducted fan section.

Engine 2 is a propulsion system conforming to the teaching of the present application, the ratio of which between the average outer radius of the high-pressure compressor and the average outer radius of the high-pressure turbine meets the formulas (1) and (2) defined above.

| | | | Engine 2 | |
|---|---|---|---|---|
| | | | (consistent with the | |
| | Engine 1 | | disclosure of the present | |
| Dimensioning parameter (SLS) | (reference engine) | | application) | |
| Average outer radius of the high- | 231.84 | | 202.5 | |
| pressure compressor (Rₑₓₜ_5) | | | | |
| Average outer radius of the high- | 276.2 | mm | 263.6 | mm |
| pressure turbine (Rₑₓₜ_7) | | | | |
| Number of stages of the high-pressure | 10 | | 10 | |
| compressor (n₅) | | | | |
| $\frac{{R}_{ext \_ 5}}{{R}_{ext \_ 7}}$ | 0.8439 | | 0.768 | |
| E * n₅ + F | 0.721 | | 0.721 | |
| E * n₅ + G | 0.821 | | 0.821 | |
| Number of stages of the high-pressure | 2 | | 2 | |
| turbine | | | | |
| Hub-to-tip ratio (1^{st} stage of the high- | 0.43 | | 0.47 | |
| pressure compressor) | | | | |
| Bypass ratio (BPR) | 11.0 | | 13.0 | |
| Fan diameter (D₉) | 2.108 | m | 2.2352 | m |
| Inlet temperature of the low-pressure | 1,027° C. | | 1,066° C. | |
| turbine (Tₑ) | | | | |
| Speed of the high-pressure shaft (N) | 19,888.07 | rpm | 22,252.16 | rpm |
| N²S₇ | 31.76 × 10¹² (rpm)²·mm² | | 30.27 × 10¹² (rpm)²·mm² | |
| $\sqrt{A * \frac{{D}_{9}^{2}}{B P R + 1} * \frac{T e}{( 572 * {N}^{2} * {S}_{7} ) 1 {0}^{- 12} - B}}$ | 203.5 | mm | 213.6 | mm |
| $\sqrt{A * \frac{{D}^{2}}{B P R + 1} * \frac{T e}{( 572 * {N}^{2} * {S}_{7} ) 1 {0}^{- 12} - C}}$ | 190.4 | mm | 198.6 | mm |
| Thrust of the fan (FN) | 158,800 N | | 151,600 N | |
| Number of fan blades | 20 | | 18 | |
| Fan pressure ratio | 1.43 | | 1.40 | |
| Hub-to-tip ratio of the fan rotor | 0.30 | | 0.30 | |
| Redline speed of the fan rotor | 3,284 | rpm | 3,039 | rpm |
| Redline speed of the high-pressure | 19,888 | rpm | 22,252 | rpm |
| shaft | | | | |
| Redline speed of the low-pressure shaft | 8,962 | rpm | 10,024 | rpm |

11 (N₁)

| | | |
|---|---|---|
| Compression ratio of the low-pressure | 1.85 | 2.51 |
| compressor | | |
| Overall compression ratio | 42 | 55 |
| Reduction ratio | 2.73 | 3.30 |
| Number of stages of the low-pressure | 2 | 3 |
| compressor | | |
| Number of stages of the low-pressure | 3 | 4 |
| turbine | | |
| Inlet temperature of the high-pressure | 1,850° C. | 1,930° C. |
| turbine | | |
| N²S₇ | 39.7 × 10⁶ rpm²·m² | 39.70 × 10⁶ rpm²·m² |
| (where S₇ is the outlet section of the | | |
| high-pressure turbine) | | |
| (where S₈ is the outlet section of the | 36.75 × 10⁶ rpm²·m² | 47.54 × 10⁶ rpm²·m² |
| low-pressure turbine) | | |

The engine 1 has a higher ratio

$$\frac{{R}_{e x {t}_{5}}}{{R}_{e x {t}_{7}}}$$

than the engine 2, for the same number of stages (ten high-pressure compressor stages and two high-pressure turbine stages). The engine 2 is therefore more compact—as can be seen by comparing the average outer radii of the high-pressure compressor and of the high-pressure turbine of the engines 1 and 2—without penalizing its efficiency or its aerodynamic load, since the hub-to-tip ratio at the inlet of the high-pressure compressor of the engine 2 remains low (which results in an increase in the height of the blades of the first stages of the high-pressure compressor and which is favorable to efficiency). The gain in compactness has a direct impact on the mass of the engine, and therefore on its specific consumption. The mechanical loading of the high-pressure turbine, which depends on the value of N²S₇, is also stable.

The fact that the high-pressure spool of the engine 2 meets the formulas (1) and (2) therefore makes it possible to reach an acceptable compromise between the radial compactness and the efficiency of the high-pressure compressor and to gain mass and specific consumption of the engine 2.

To move from the (reference) engine 1 to the engine 2 (consistent with the disclosure), the fan diameter D and the bypass ratio BPR were increased, which allowed increasing the propulsive efficiency and maintaining comparable thrust given the decrease in the pressure ratio of the fan 2. Moreover, the overall compression ratio was increased, as was the inlet temperature of the high-pressure turbine 8, which allowed increasing the thermal efficiency of the propulsion system 1. Finally, insofar as the temperature of the low-pressure turbine 7 was kept stable, it was possible to increase its mechanical loading (N₁₂S) by reducing its number of stages.

The increase of the power density of the high-pressure compressor of the engine 2 can be achieved as follows:
increase of the compression ratio of the high-pressure compressor;
reduction of the diameter of the low-pressure shaft while maintaining an acceptable supercritical dynamic situation (first deformation mode within the operating range, in an operating area in which the dynamic situation of the low-pressure shaft 11 can be controlled
typically, for a propulsion system comprising a reduction mechanism 19, the first deformation mode of the low-pressure shaft 11 occurs at a transient speed corresponding for example to a speed lower than the idle speed and is therefore not likely to damage the propulsion system 1. Thus, a transient speed that only occurs for a very short time in the operation of the propulsion system 1 is chosen—the second deformation mode outside the operating range) via a modification of the internal geometry of the low-pressure shaft and an increase of the distance between the bearings downstream of the low-pressure turbine;
better integration of the upstream bearing of the high-pressure spool combined with the reduction of the low-pressure shaft diameter allows a lowering of the internal path. This better integration can be achieved for example by using rolling elements made of ceramic material, which allow an increase of the contact pressure and a reduction of the thermal rejections.

Alternatively, instead of reducing the diameter of the low-pressure shaft, it is possible to modify the shape of the low-pressure shaft to give it a bottle shape: particularly, the radius of the low-pressure shaft under the high-pressure turbine is modified so as to maintain the dynamic situation of the low-pressure shaft and its radius upstream of the combustion chamber is reduced so as to facilitate the integration of the internal path of the high-pressure compressor. The reduction of the aerodynamic load of the high-pressure turbine also increases its diameter and facilitates the design of the high-pressure turbine disk.

1. A propulsion system comprising:
a fan rotor connected to a fan shaft;
a first spool comprising a first turbine configured to drive the fan rotor via a first shaft;
a second spool comprising a second turbine and a second axial compressor, the second turbine being a two-stage turbine and being configured to drive the second compressor via a second shaft, the second shaft being configured to rotate at a higher speed than a rotation speed of the first shaft and a hub-to-tip ratio at an inlet of the second compressor being between 0.41 and 0.60;
a reduction structure coupling the first shaft and the fan shaft to drive the fan shaft at a rotation speed lower than the rotation speed of the first shaft;
wherein the second spool meets the following formula:
$$( E * {n}_{5} + F ) < \frac{{R}_{ext \_ 5}}{{R}_{ext \_ 7}} < ( E * {n}_{5} + G )$$
where:
R_{ext_5} is an average outer radius of the second compressor in millimeters;
R_{ext_7} is an average outer radius of the second turbine, in millimeters;
n₅ is a number of stages in the second compressor; and
$$E = - 2.39 ⋆ {10}^{- 3} square millimeters , F = 0.96 and G = 1.06 .$$

2. The propulsion system according to claim 1, wherein the average outer radius of the second compressor meets the following formula:
$${R}_{ext \_ 5} < \sqrt{A * \frac{{D}_{9}^{2}}{B P R + 1} * \frac{T e}{( 572 * {N}^{2} * {S}_{7} ) 1 {0}^{- 12} - B}}$$
D₉ is a diameter of the fan rotor in millimeters, measured in a plane normal to an axis of rotation of the fan rotor at an intersection between a tip and a leading edge of blades of the fan rotor;
BPR is a bypass ratio of the propulsion system and is measured when the propulsion system is stationary in take-off rating in a standard atmosphere and at sea level;
Tₑ is a maximum inlet temperature of the first turbine when the propulsion system is stationary in take-off rating in a standard atmosphere and at sea level and is expressed in degrees Celsius;
N is a rotation speed of the second shaft and is measured when the propulsion system is stationary in take-off rating in a standard atmosphere and at sea level, in revolutions per minute;
S₇ is an average surface area of the second turbine expressed in square millimeters; and
$$A = 1 {( rpm )}^{2} \cdot mm / ° C . and B = 8 , 977 {( rpm )}^{2} ⋆ {mm}^{2} .$$

3. The propulsion system according to claim 1, wherein the average outer radius of the second compressor meets the following formula:
$${R}_{ext \_ 5} > \sqrt{A * \frac{{D}^{2}}{B P R + 1} * \frac{T e}{( 572 * {N}^{2} * {S}_{7} ) 1 {0}^{- 12} - C}}$$
where:
D₉ is a diameter of the fan rotor in millimeters, measured in a plane normal to an axis of rotation of the fan rotor at an intersection between a tip and a leading edge of the blades of the fan rotor;
BPR is a bypass ratio of the propulsion system and is measured when the propulsion system is stationary in take-off rating in a standard atmosphere and at sea level;
Tₑ is a maximum inlet temperature of the first turbine when the propulsion system is stationary in take-off rating in a standard atmosphere and at sea level and is expressed in degrees Celsius;
N is a rotation speed of the second shaft and is measured when the propulsion system is stationary in take-off rating in a standard atmosphere and at sea level, in revolutions per minute;
S₇ is an average surface area of the second turbine expressed in square millimeters; and
$$C = 7 , 668 {( rpm )}^{2} ⋆ {mm}^{2} .$$

4. The propulsion system according to claim 1, wherein the second compressor comprises at least eight stages and at most eleven stages.

5. The propulsion system according to claim 1, wherein the diameter of the fan rotor is between 80 inches and 185 inches inclusive.

6. The propulsion system according to claim 1, wherein a bypass ratio of the propulsion system is greater than or equal to 10.

7. The propulsion system according to claim 1, wherein the fan section is ducted with a bypass ratio of the population system being between 10 and 35, or is unducted with the bypass ratio of the propulsion system being between 40 and 80 inclusive.

8. The propulsion system according to claim 1, wherein a rotation speed of the second shaft is greater than or equal to 15,000 revolutions per minute and less than or equal to 27,000 revolutions per minute.

9. The propulsion system according to claim 1, wherein an overall compression ratio of the propulsion system, corresponding to a ratio between an outlet pressure of the second compressor and an inlet pressure of the fan rotor, is greater than or equal to 40 and less than or equal to 70.

10. The propulsion system according to claim 1, wherein the first turbine comprises at least three and at most five stages.

11. The propulsion system according to claim 1, wherein the first turbine further drives a first compressor via the first shaft, the first compressor comprising at least two and at most four stages.

12. The propulsion system according to claim 1, wherein the fan section has a fan pressure ratio, corresponding to a pressure ratio between an outlet of the fan rotor and an inlet of the fan rotor that is less than or equal to 1.45.

13. The propulsion system according to claim 1, wherein a compression ratio of the second compressor is greater than or equal to 18 when the propulsion system is in cruising condition.

14. An aircraft comprising:
at least one of the propulsion system according to claim 1,
wherein the at least one of the population system is fixed to the aircraft via a mast.

15. An operating method for operating a propulsion system comprising a reduction structure coupling a first turbine of a first spool and a fan rotor to drive the fan rotor at a lower speed than a speed of the first turbine, and a second spool comprising a second two-stage turbine and a second axial compressor configured to rotate at a higher speed than the first turbine, a hub-to-tip ratio at the inlet of the second compressor being comprised between 0.41 and 0.60, wherein the second spool is dimensioned so as to meet the following formula:
$$\frac{{R}_{ext \_ 5}}{{R}_{ext \_ 7}} > ( E * {n}_{5} + F ) < \frac{{R}_{ext \_ 5}}{{R}_{ext \_ 7}} < ( E * {n}_{5} + G )$$
where: R_{ext_5} is an average outer radius of the second compressor in millimeters;
R_{ext_7} is an average outer radius of the second turbine, in millimeters;
n₅ is a number of stages in the second compressor; and
$$E = - 23.9 ⋆ {10}^{- 3} square millimeters , F = 0. 96 and G = 1.06 ,$$
the method comprising operating the population system comprising the second spool that has been dimensioned.

16. The operating method according to claim 15,
wherein the second compressor is dimensioned such that the average outer radius of the second compressor meets the following formula:
$${R}_{ext \_ 5} > \sqrt{A * \frac{{D}^{2}}{B P R + 1} * \frac{T e}{( 572 * {N}^{2} * {S}_{7} ) 1 {0}^{- 12} - B}}$$
where:
D₉ is a diameter of the fan rotor in millimeters, measured in a plane normal to an axis of rotation of the fan rotor at an intersection between a tip and a leading edge of the blades of the fan rotor;
BPR is a bypass ratio of the propulsion system and is measured when the propulsion system is stationary in take-off rating in a standard atmosphere and at sea level;
Tₑ is a maximum inlet temperature of the first turbine when the propulsion system is stationary in take-off rating in a standard atmosphere and at sea level and is expressed in degrees Celsius;
N is a rotation speed of the second shaft and is measured when the propulsion system is stationary in take-off rating in a standard atmosphere and at sea level, in revolutions per minute;
S₇ is an average surface area of the second turbine expressed in square millimeters; and
$$A = 1 {( rpm )}^{2} \cdot mm / ° C . and B = 8 , 977 {( rpm )}^{2} ⋆ {mm}^{2} .$$

17. The operating method according to claim 15, wherein the second compressor is dimensioned such that the average outer radius of the second compressor meets the following formula:
$${R}_{ext \_ 5} < \sqrt{A * \frac{{D}^{2}}{BPR + 1} * \frac{T e}{( 572 * {N}^{2} * {S}_{7} ) 1 {0}^{- 12} - C}}$$
where:
D₉ is the diameter of the fan rotor in millimeters, measured in a plane normal to an axis of rotation of the fan rotor at an intersection between a tip and a leading edge of the blades of the fan rotor;
BPR is a bypass ratio of the propulsion system and is measured when the propulsion system is stationary in take-off rating in a standard atmosphere and at sea level;
Tₑ is a maximum inlet temperature of the first turbine when the propulsion system is stationary in take-off rating in a standard atmosphere and at sea level and is expressed in degrees Celsius;
N is a rotation speed of the second shaft and is measured when the propulsion system is stationary in take-off rating in a standard atmosphere and at sea level; in revolutions per minute;
S₇ is an average surface area of the second turbine expressed in square millimeters; and
$$C = 7 , 668 {( rpm )}^{2} ⋆ {mm}^{2} .$$

18. The operating method according to claim 15, wherein the second compressor is dimensioned such that a compression ratio of the second compressor is greater than or equal to 18 when the propulsion system is in cruising condition.

19. A method for manufacturing a propulsion system comprising the following steps:
dimensioning the propulsion system, wherein the propulsion system comprises a reduction structure coupling a first turbine of a first spool and a fan rotor to drive the fan rotor at a lower speed than a speed of the first turbine, and a second spool comprising a second two-stage turbine and a second axial compressor configured to rotate at a higher speed than the first turbine, a hub-to-tip ratio at the inlet of the second compressor being comprised between 0.41 and 0.60, wherein the second spool is dimensioned so as to meet the following formula:
$$\frac{{R}_{ext \_ 5}}{{R}_{ext \_ 7}} > ( E * {n}_{5} + F ) < \frac{{R}_{ext \_ 5}}{{R}_{ext \_ 7}} < ( E * {n}_{5} + G )$$
where:
R_{ext_5} is an average outer radius of the second compressor in millimeters;
R_{ext_7} is an average outer radius of the second turbine, in millimeters;
n₅ is a number of stages in the second compressor; and
$$E = - 23.9 ⋆ {10}^{- 3} square millimeters , F = 0.96 and G = 1.06$$
and
manufacturing the propulsion system that has been dimensioned.

20. The propulsion system according to claim 1, wherein the diameter of the fan rotor is between 85 inches and 120 inches inclusive.
